(19) United States
(12) Patent Application Publication
(10) Pub. No.: US 2007/0186788 A1
(43) Pub. Date: Aug. 16, 2007

(54) Nutcracker

(75) Inventor: Noboru Yachi, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: YATCH CO., LTD., Higashiosaka-shi (JP)

(21) Appl. No.: 11/355,179

(22) Filed: Feb. 16, 2006

(51) Int. Cl. A01J 11/00

(52) U.S. Cl. 99/468

(57) ABSTRACT

The nutcracker comprising: a nut housing case made of synthetic resin wherein an opening for inserting a nut is formed on one side of the case; a screw axis made of synthetic resin provided in the case to be movable through a screw hole formed in the case; a handle portion made of synthetic resin provided in a section on the screw axis outside the case; and an openable and closable lid body made of synthetic resin used for closing the opening of the case, wherein a metallic pressing member for applying pressure to the shell of the nut housed inside the case and for cracking the nut is attached to the end portion of the screw axis on the side of the case, and a mounting base made of synthetic resin for mounting the nut is provided in a section for mounting and supporting the nut inside the case.

### BACKGROUND OF THE INVENTION

1. Field of the Invention

The present invention relates to a manual nutcracker used for housing a nut with a hard shell, such as a chestnut, walnut, pecan, ginkgo, plum seed, macadamia nut, and for cracking the shell of the housed nut.

2. Description of the Related Art

Examples of the nutcracker described above include the one which had been proposed by the present applicant. This nutcracker comprises a nut housing case in the shape of a box in which an opening for inserting a nut is formed on a front side of the nut housing case, a screw axis provided in the case so as to be movable through a screw hole which is formed in a vertical direction in a penetrating fashion on an upper wall of the case, a handle portion provided, protruding from an upper end of the screw axis to the outside of the case, and an openable and closable lid body made of synthetic resin, which is used for closing the opening of the nut housing case, wherein a pressing member for applying pressure and cracking a nut contained inside the case is attached to a lower end of the screw axis. The pressing member is configured with metal, but the other members are configured with synthetic resin so that this nutcracker can be advantageous in terms of weight reduction (see, for example, Japanese Patent Application No. 3683241 (see FIG. 1 through FIG. 4).

In Japanese Patent Application No. 3683241 (see FIG. 1 through FIG. 4), a bottom portion for supporting a nut contained inside a nut housing case is provided with a right and left pair of convex portions for defining the position of the nut, but the pair of right and left convex portions are not sufficient for reliably defining the position of the nut, thus the center of the nut cannot be applied with pressure by the pressing member. For this reason, excessive pressing force acts on a specific part of the nut housing case, whereby a crack could be generated on the nut housing case by using it for a long period of time, or, according to the circumstances, the nut housing case itself could be broken.

A problem to be solved by the present invention in view of such circumstances is to provide a nutcracker capable of reliably positioning a nut in a predetermined position and reliably applying pressure to substantially the center of the nut by means of a pressing member.

### SUMMARY OF THE INVENTION

In order to solve the abovementioned problem, a nutcracker of the present invention comprises: a nut housing case made of synthetic resin in which an opening for inserting a nut is formed on one side of the nut housing case; a screw axis made of synthetic resin, which is provided in the case so as to be movable through a screw hole formed in the nut housing case; a handle portion made of synthetic resin, which is provided in a section on the screw axis outside the nut housing case; and an openable and closable lid body made of synthetic resin, which is used for closing the opening of the nut housing case, wherein a metallic pressing member for applying pressure to the shell of a nut and cracking the nut housed inside the case is attached to the end portion of the screw axis on the side of a nut housing case, and a mounting base made of synthetic resin, which is for mounting the nut, is provided in a section for mounting and supporting the nut inside the nut housing case.

By providing the special mounting base for mounting a nut in the nut housing case as described above, the nut can be mounted on the mounting base after reliably defining the position of the nut. Furthermore, after mounting the nut on the mounting base, the nut housing case is closed with the lid body and the handle portion is operated by rotating it, whereby pressure is applied to substantially the center of the nut by the pressing member, and the shell of the nut can be cracked. At this moment, shell fragments can be reliably prevented from scattering to the outside by means of the lid body. The members other than the pressing members on which the reaction force of the nut acts most are configured with synthetic resin, whereby the weight of the nut housing case can be lightened.

A through-hole is formed in a section located immediately below the mounting base of the nut housing case, and the through-hole may be covered with the mounting base.

A protruding portion which enters the through-hole may be provided on the opposite side of the mounting surface of the mounting base, and the protruding portion may be allowed to enter the through-hole to fix the mounting base to the nut housing case by welding means.

A pressing surface of the pressing member may be configured to be flat, the mounting base may be configured to be circular or elliptical in plan view, and the mounting surface of the mounting base may be configured to be curved so as to be in the form of an arc in which the dent becomes deeper towards the center.

An external diameter of the pressing member may be set smaller than an external diameter of the screw axis.

The nut housing case may comprise an inner case portion for containing a nut and an outer case portion positioned on the outside of the inner case portion, and the inner case portion and the outer case portion may be coupled by means of a plurality of reinforcing ribs.

By providing the special mounting base for mounting a nut in the nut housing case, a nut can be reliably placed on a predetermined position by using the mounting base, pressure is applied to substantially the center of the nut by the pressing member, and the shell of the nut can be cracked. Therefore, the nut housing case can be reliably prevented from being cracked by excessive pressing force acting on a specific part of the nut housing case, or the nut housing case itself can be reliably prevented from being broken. Moreover, when applying pressure to the nut, shell fragments can be reliably prevented from scattering to the outside by means of the lid body. In addition, the members other than the pressing members on which the reaction force of the nut acts most are configured with synthetic resin, whereby the weight of the nut housing case can be lightened.

By forming the through-hole in a section for mounting and supporting a nut contained inside the nut housing case, when molding the nut housing case with synthetic resin to have at least a predetermined thickness (for example, 5 mm), the generation of air bubbles in the synthetic resin can be avoided, and local deterioration of the strength of the nut housing case can be avoided. Furthermore, by covering the through-hole with the mounting base, shell fragments of a cracked nut are not discharged to the outside through the through-hole.

By providing the protruding portion, which enters the through-hole, on the opposite side of the mounting surface of the mounting base, and by allowing the protruding portion to enter the through-hole to fix the mounting base to the nut housing case by means of welding means, positioning of the nut at the time of welding can be performed easily, and the mounting base can be reliably fixed to a predetermined position. As the welding means, ultrasonic welding is the most appropriate welding method, but thermal welding may be used.

By configuring the pressing surface of the pressing member to be flat, and configuring the mounting base to be circular or elliptical when viewed two-dimensionally, and further configuring the mounting surface of the mounting base to be curved so as to be in the form of an arc in which the dent becomes deeper towards the center, a nut with numbers of circular or elliptical parts can be stably supported by the mounting base having the mounting surface which is formed to have shape resembling the external shape of the nut, and at the same time the nut can be applied with pressure by the pressing member having the flat surface with the shape different from that of the nut, whereby the pressing member is not embedded in the nut and the shell of the nut can be reliably cracked.

By setting the external diameter of the pressing member to be smaller than the external diameter of the screw axis, the strength of the screw axis can be maintained to a predetermined strength, and at the same time the metallic pressing member having a large strength can be reduced in size to reduce the weight of the nut housing case.

By allowing the nut housing case to comprise an inner case portion for containing a nut and an outer case portion positioned on the outside of the inner case portion, and by coupling the inner case portion and the outer case portion by means of a plurality of reinforcing ribs, the nut housing case can be lightened, and at the same time the strength of the entire case can be increased.

### BRIEF DESCRIPTION OF THE DRAWINGS

FIG. 1 is a front view of a nutcracker;

FIG. 2 is a side view of the nutcracker;

FIG. 3 is a front view of the nutcracker in which a lid body is removed;

FIG. 4 is a rear view of the nutcracker;

FIG. 5 is a cross-sectional view taken along the line I-I of FIG. 1;

FIG. 6 is across-sectional view taken along the line II-II of FIG. 1; and

FIG. 7 is a perspective view showing a substantial part of the periphery of a mounting base.

### DESCRIPTION OF THE PREFERRED EMBODIMENTS

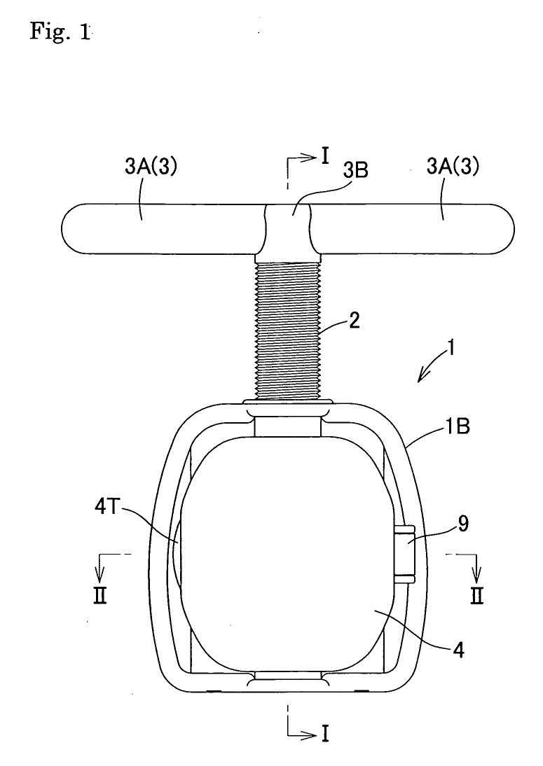

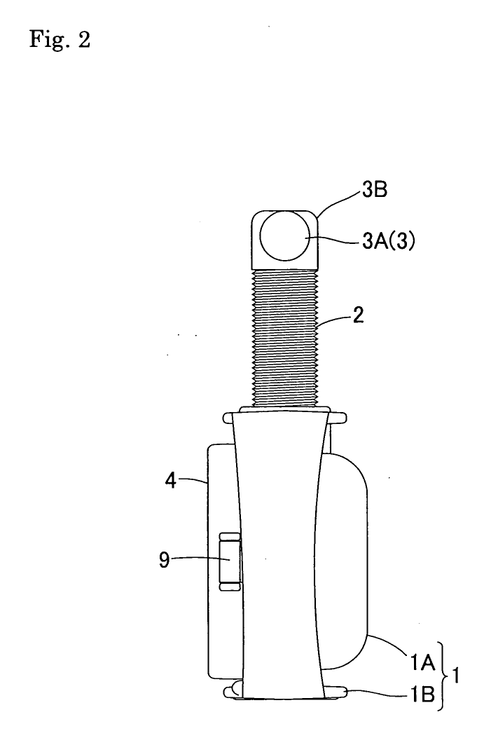

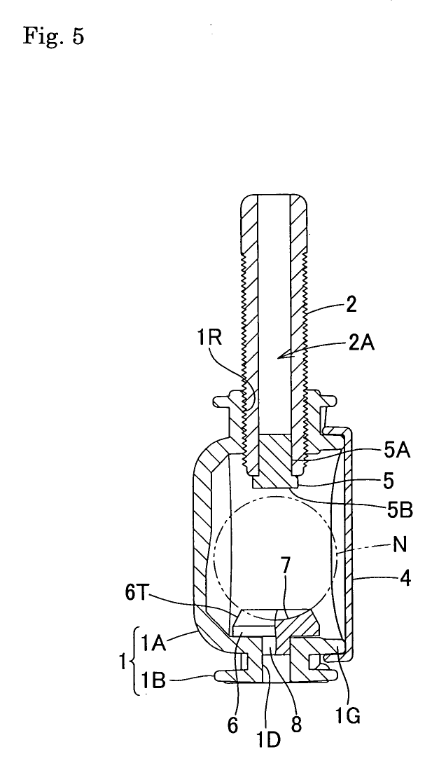

FIG. 1 through FIG. 5 show a manual nutcracker (referred to as “nutcracker” hereinafter) for containing a nut and cracking the shell of the nut. This nutcracker comprises: a nut housing case 1 made of synthetic resin in which an opening 1K into which a nut N is inserted is formed on the front side (one side) of the nut housing case, the external shape of the nut housing case being formed to have a square shape substantially; a screw axis 2 made of synthetic resin, which is provided in the case 1 so as to be movable through a screw hole 1R (shown in FIG. 5) which is formed in a vertical direction on an upper wall configuring the nut housing case 1; a handle portion 3 made of synthetic resin, which is provided, outside the nut housing case 1, in a section on the screw axis 2, and which is composed of rod-like bodies 3A, 3A configured linearly to extend in a horizontal direction from two locations which are 180 degrees apart from each other in a circumferential direction of an upper end portion 3B that is integrally formed in the upper end as shown in the figure; and an openable and closable lid body 4 made of synthetic resin, the external shape of which is in the form of substantially a square shape, and which is used for closing the opening 1K of the nut housing case 1, wherein a nut housing case side end portion, that is, a lower end portion, of the screw axis 2 is attached with a metallic pressing member 5, a pressing surface 5B as the lower surface of which is configured to be a flat disk-like shape, and which is used for applying pressure and cracking a nut contained inside the case 1. The external diameter of the pressing member is set to be smaller than the external diameter of the screw axis 2. The shape of the nut housing case 1 may be any shape such as an elliptical, polygonal, or rectangular shape. Although there is an advantage that the number of components can be reduced by integrally forming the handle portion 3 on the upper end of the screw axis 2, the handle portion 3 and the screw axis 2 may be formed separately, and the both may be integrated. The specific configuration of the handle portion 3 is not limited to the one shown in the figures. A screw may be formed on an external surface extending throughout substantially the whole area in the vertical direction, except the handle portion 3 of the screw axis 2, whereby the range of movement may be made wider, but the screw may be formed only in a part of the screw axis 2. For the pressing member 5, stainless steel (for example, SUS 303) is preferable in terms of its corrosion resistance property, but various other metals may be used. It should be noted that the surfaces of the various metals may be applied with an anti-corrosion coating. Further, the members 1 through 4 other than the pressing member 5 may be molded by means of various synthetic resins.

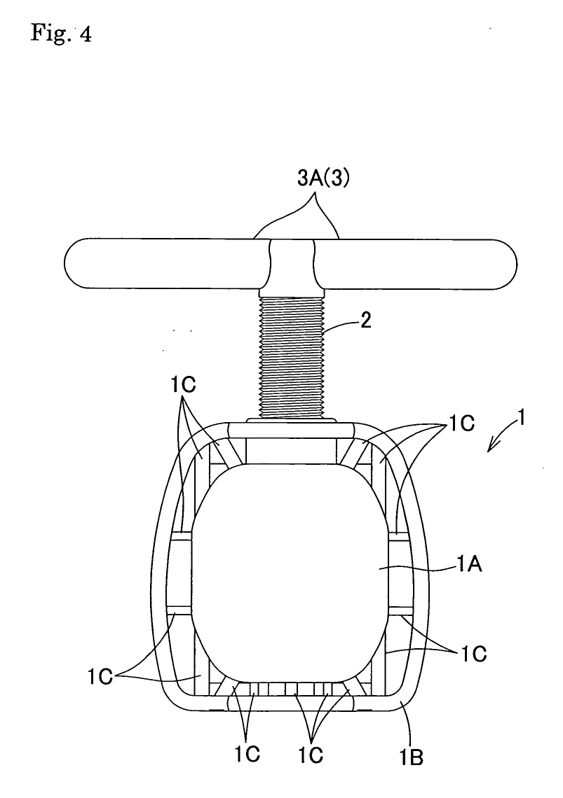

The nut housing case 1 comprises an inner case portion 1A for containing the nut N, and an outer case portion 1B which is placed outside the inner case portion 1A and has the front and back width which is smaller than that of the inner case portion 1A when viewed two-dimensionally. As shown in FIG. 4, the inner case portion 1A and the outer case portion 1B are coupled by means of a plurality of reinforcing ribs 1C, whereby the nut housing case 1 can be lightened and at the same time the strength thereof can be increased.

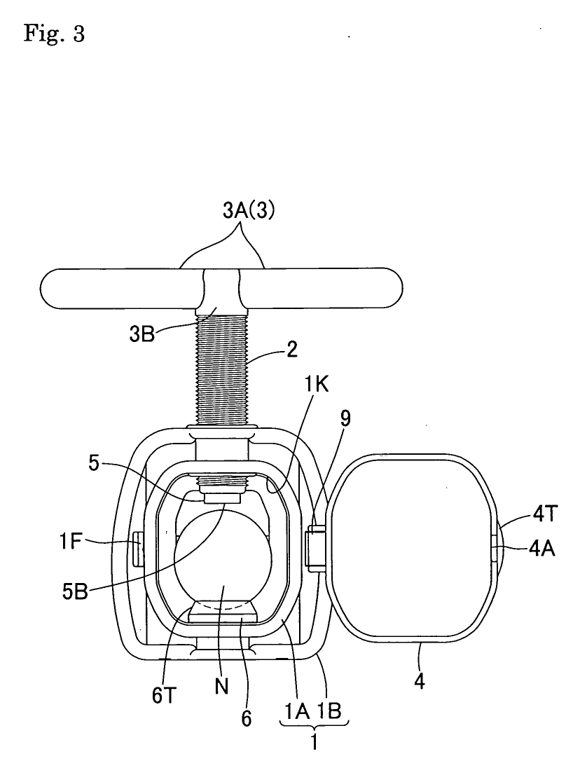

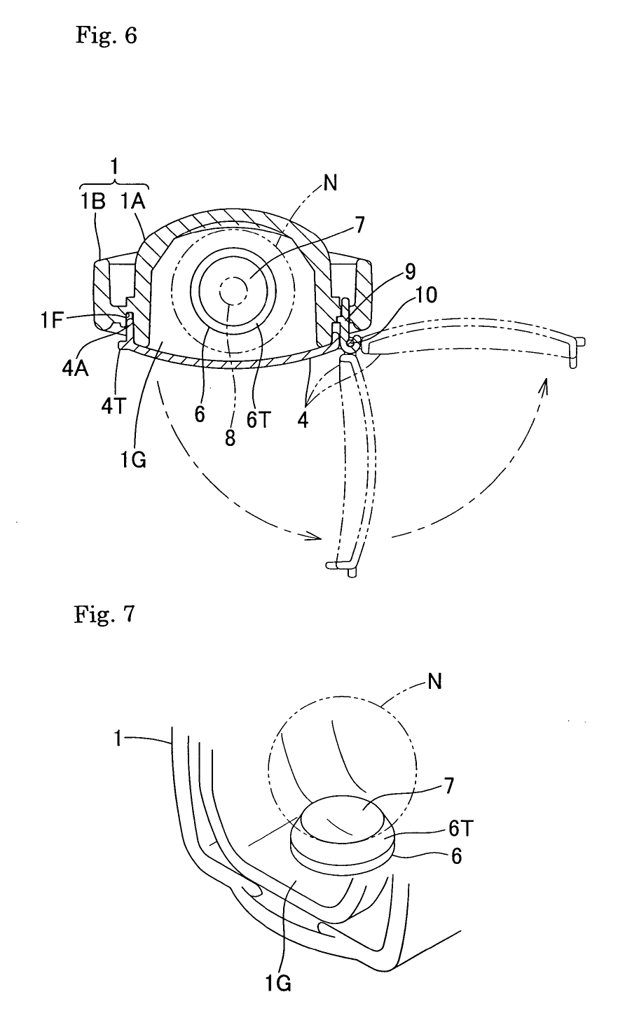

A shown in FIG. 3, FIG. 5, FIG. 6 and FIG. 7, a section for mounting and supporting the nut N, which is located on a lower wall 1G configuring the nut housing case (substantially the center portion of the lower wall), is provided with a mounting base 6 for mounting and supporting the nut N.

In order to stably mount the nut N, the diameter of the mounting base 6 is made larger than that of the screw axis 2, the shape of the mounting base 6 is formed to have a curved surface (see FIG. 5) which is, when viewed two-dimensionally, in a circular shape having a diameter which is slightly smaller than the depth of the nut housing case 1, and in the form of an arc in which a mounting surface 7 of the mounting base 6 dents deeper towards the center. However, the shape of the mounting base may be elliptical when viewed two-dimensionally, or, in some cases, rectangular or square. Also, the size of the mounting base 6 can be changed freely. An upper outer peripheral surface 6T of the mounting base 6 is tapered towards substantially the center portion on the upper end side, and the angle formed between the tapered surface 6T and the mounting surface 7 can be made large, compared to the case in which the upper outer peripheral surface 6T is formed to be vertical. Therefore, there is an advantage that the upper end tip portion can be configured to have an excellent strength so that no cracks are generated, but the upper outer peripheral surface 6T may be formed to be vertical.

In the center portion of the lower wall 1G of the nut housing case, which is the section for mounting and supporting the nut N, that is, in a section immediately below the mounting base 6, there is formed a circular (or may be elliptical, triangular, or square) through-hole 1D so that no air bubbles are generated in the synthetic resin when molding the nut housing case 1. Particularly, when molding the nut housing case 1 to have a thickness of at least 5 mm, air bubbles are not generated in the synthetic resin by forming the through-hole 1D, thus the nut housing case 1 can be molded. By setting the diameter of the through-hole 1D to 8 mm through 10 mm, the generation of air bubbles can be reliably avoided, and at the same time deterioration of the strength of the completed nut housing case 1 can be avoided as much as possible, but the diameter of the through-hole 1D is not limited to the above values.

By providing a cylindrical protruding portion 8, which enters the through-hole 1D without leaving any spaces therebetween, on the opposite side of the mounting surface of the mounting base 6 (see FIG. 5), and by allowing the protruding portion 8 of the mounting base 6 to enter the through-hole 1D without leaving any spaces therebetween, to fix the mounting base 6 to the nut housing case 1 by means of ultrasonic welding (welding means), positioning of the nut at the time of welding can be performed easily, and the mounting base 6 can be reliably fixed to a predetermined position. It should be noted that the section or range for performing the welding may be set to a section or range in which the mounting base 6 is not easily detached. Therefore, there are advantages that the through-hole 1D can be used as a hole for attaching the mounting base 6, and that the mounting base 6 can be used as a over member for covering the through-hole 1D. When the through-hole 1D is not formed, the mounting base 6 may be fixed to an upper surface (inner surface) of the lower wall of the nut housing case 1 by means of the welding means or bonding means such as an adhesive. By configuring the mounting base 6 with the same synthetic resin as that of the nut housing case 1, the welding force can be enhanced.

As shown in FIG. 5, the screw axis 2 is configured to have a cylindrical body in which the inner portion thereof is hollow. A fitting portion 5A, which fixedly fits the pressing member 5 thereto by inserting the pressing member 5 into the inner portion 2A from one end of the cylindrical body 2, is integrally formed on an upper end of the pressing member 5, whereby the screw axis 2 can be lightened, and the hollow inner portion 2A can be used as a fitted portion for fixedly fitting the fitting portion 5A of the pressing member 5. Although not shown in the figures, a convex portion, which is locked with a concave portion formed inside the screw axis 2, may be formed on the surface of the fitting portion 5A of the pressing member 5 so that the pressing member 5 is not easily pulled out from the screw axis 2, or the fitting portion 5A of the pressing member 5 ma be fitted to the inside of the screw axis 2 after applying an adhesive onto the surface of the fitting portion 5A of the pressing member 5.

As shown in FIG. 1, FIG. 4, and FIG. 6, the lid body 4 is attached to a supporting member 9 provided on one of the right and left sides of the nut housing case 1, via a pivoted pin 10 so as to be able to swing around the vertical axis. However, the configuration for placing or removing the lid body 4 can be changed freely to, not only the swinging fashion shown in the figures, but also slidable fashion or embedding fashion. The opposite end of a swinging coupling portion on one side (right side in the figures) of the lid body 4 is provided with a fixable and releasable locking piece 4A which locks with a concave portion 1F formed on the left side of the nut housing case 1 and is capable of fixing the lid body 4 to the nut housing case 1, and a protruding piece 4T which can be hooked with a finger in order to open the locked and fixed lid body 4.

To explain the case in which the shell of the nut N is cracked using the nutcracker configured as described above, as shown in FIG. 3, after operating the lid body 4 to open the nut housing case, the nut N is mounted on the mounting base 6 inside the nut housing case 1. Next, the placed lid body 4 is operated to close the nut housing case, thereafter the nut housing case 1 is held with one hand, and the handle portion 3 is rotated with the other hand, whereby the pressure is applied to the shell of the nut N and the nut N is cracked. Shell fragments that scatter due to application of the pressure to the shell of the nut N are received by the lid body 4, thus the shell fragments are not scattered to the outside the nut housing case 1 through the opening of the nut housing case 1, but are contained together with the nut N inside the nut housing case 1. Therefore, the nut N and the shell fragments can be removed by operating the lid body 4 to open the nut housing case.

What is claimed is:

1. A nutcracker, comprising:
a nut housing case made of synthetic resin in which an opening for inserting a nut is formed on one side of the nut housing case;
a screw axis made of synthetic resin, which is provided in the case so as to be movable through a screw hole formed in the nut housing case;
a handle portion made of synthetic resin, which is provided in a section on the screw axis outside the nut housing case; and
an openable and closable lid body made of synthetic resin, which is used for closing the opening of the nut housing case, wherein
a metallic pressing member for applying pressure to the shell of the nut housed inside the case and for cracking the nut is attached to the end portion of the screw axis on the side of a nut housing case, and
a mounting base made of synthetic resin, which is for mounting the nut, is provided in a section for mounting and supporting the nut inside the nut housing case.

2. The nutcracker according to claim 1, wherein a through-hole is formed in a section located immediately below the mounting base of the nut housing case, and the through-hole is covered with the mounting base.

3. The nutcracker according to claim 2, wherein a protruding portion which enters the through-hole is provided on the opposite side of a mounting surface of the mounting base, and the protruding portion is allowed to enter the through-hole to fix the mounting base to the nut housing case by welding means.

4. The nutcracker according to claim 1, wherein a pressing surface of the pressing member is configured to be flat, the mounting base is configured to be circular or elliptical in plan view, and the mounting surface of the mounting base is configured to be curved so as to be in the form of an arc in which the dent becomes deeper towards the center.

5. The nutcracker according to claim 1, wherein an external diameter of the pressing member is set smaller than an external diameter of the screw axis.

6. The nutcracker according to claim 1, wherein the nut housing case comprises an inner case portion for housing a nut and an outer case portion positioned on the outside of the inner case portion, and the inner case portion and the outer case portion are coupled by means of a plurality of reinforcing ribs.
